(19) United States
(12) Patent Application Publication
(10) Pub. No.: US 2013/0076041 A1
(43) Pub. Date: Mar. 28, 2013

(54) Lighter-than-Air Gas Filled Tower of Wind Turbine

(71) Applicant: Philip Merryman, (US)

(72) Inventor: Philip Merryman, (US)

(21) Appl. No.: 13/244,471

(22) Filed: Sep. 24, 2011

(51) Int. Cl. F03D 9/00

(52) U.S. Cl. 290/55

(57) ABSTRACT

This application seeks to patent the employment of Lighter-than-Air Gas inside the Tower of a Wind Turbine to lower the effective weight of the Wind Turbine on the supporting Tower and consequently decrease the amount of material required to construct the Tower.

### BACKGROUND OF THE INVENTION

Wind Turbines are placed atop towers, usually constructed of steel, of varying heights. Due to the immense weight of the Wind Turbine, the Tower holding the Wind Turbine aloft has to be constructed out of a large amount of material to support the Wind Turbine. Otherwise, the Tower could buckle at any point due to the weight above it.

### BRIEF SUMMARY OF THE INVENTION

In order to minimize the use of material in the Tower to support the Wind Turbine, the Tower is filled with a Lighter-than-Air Gas, such as Helium, to exert a lifting force against the Wind Turbine at the top of the Tower.

### DETAILED DESCRIPTION OF THE INVENTION

A Lighter-than-Air Gas, such as Helium, is injected into the Tower of a Wind Turbine to exert a force greater than the Earth's surface atmospheric pressure against the base of the Wind Turbine, which is inserted into the top of the Tower as a plug. The compressed Lighter-than-Air Gas exerts an upward pressure against the base of the Wind Turbine, thereby lowering the effective weight of the Wind Turbine on the Tower. This in turn lowers the amount of steel or other material needed to assure the Tower's structural integrity.

1. The use of Lighter-than-Air Gas in the interior of a Tower of a Wind Turbine to provide a lifting force against the Wind. Turbine's base.
